(19) United States
(12) Patent Application Publication
(10) Pub. No.: US 2001/0039549 A1
(43) Pub. Date: Nov. 8, 2001

(54) Object-oriented interface to LDAP directory

(76) Inventors: Danny K. Eng, Union City, CA (US); Jeffrey T. Tuatini, San Francisco, CA (US)

Correspondence Address: PERKINS COIE LLP, PATENT-SEA, P.O. BOX 1247, SEATTLE, WA, 98111-1247, US

(21) Appl. No.: 09/753,035

(22) Filed: Dec. 28, 2000

Related U.S. Application Data
(60) Provisional application No. 60/173,662, filed on Dec. 30, 1999.

(51) Int. Cl. G06F 17/30

(52) U.S. Cl. 707/205; 707/100

(57) ABSTRACT

A method and system for providing an object-oriented interface to a directory server is provided. The interface system includes a directory compiler and directory interface objects. The directory compiler inputs a schema of a directory and outputs the definitions of various interfaces and objects (e.g., adapters) related to that directory. An application program can then use the interfaces and adapter objects to access the directory in an object-oriented manner.

### CROSS-REFERENCE TO RELATED APPLICATION

This application claims the benefit of U.S. Provisional Patent Application No. 60/173,662, entitled “OBJECT-ORIENTED INTERFACE TO LDAP DIRECTORY,” filed on Dec. 30, 1999 (Attorney Docket No. 243768007 US), which is hereby incorporated by reference.

### TECHNICAL FIELD

The described technology relates generally to accessing a lightweight directory.

### BACKGROUND

Computer systems often use a directory service, which is a specialized database for providing access to attribute-based data, to store characteristics relating to equipment and users. The directories typically contain descriptive information and support sophisticated filtering capabilities. A directory service typically does not need to provide the support necessary for complicated transactions or roll-back schemes employed by database management systems designed for handling high-volumes of transactions. Directory services are typically optimized for high-volume lookup and quick response.

One popular directory service is provided by the Open LDAP organization (www.openldap.org). The Lightweight Directory Access Protocol (“LDAP”) uses a directory model that provides a hierarchical, tree-like structure of directory entries. For example, the structure typically reflects the geographic or organizational boundaries of the organization that uses the directory. Directory entries that represent countries are at the top of the hierarchy, and directory entries that represent states and national organizations are lower in the hierarchy. FIG. 1A represents a directory hierarchy. Each node of a hierarchy represents a directory entry. Nodes (or directory entries) 110 and 111 represent the countries Great Britain and the U.S. Each directory entry has attributes associated with it (e.g., country name). The attributes may be required or optional. Each directory entry also has an objectclass attribute (not shown) that specifies the schema for the directory entry. LDAP defines operations for interrogating and updating the directory entries. These operations are typically provided through an application programming interface (“API”). A difficulty with the use of such an API is that many application programs are developed using an object-oriented model. The use of an API to access a directory service is not consistent with such an object-oriented model. It would be desirable to have a technique for accessing a directory service that was consistent with an object-oriented model.

### BRIEF DESCRIPTION OF DRAWINGS

FIG. 1A represents a directory hierarchy.

FIG. 1B is a block diagram illustrating the directory compiler.

FIG. 2 is a block diagram illustrating an LDAP schema and LDAP as directory entries.

FIG. 3 is a block diagram illustrating the objects generated to access an LDAP directory.

FIG. 4 is a flow diagram illustrating example processing of a lookup method of the directory manager class.

FIG. 5 is a flow diagram illustrating an example get adapter instance method of the directory manager class.

FIG. 6 is a flow diagram illustrating example uses of the object-oriented interface of an LDAP directory.

FIG. 7 is a block diagram illustrating components of the interface system in this alternate embodiment.

FIG. 8 is a block diagram illustrating objects of instantiated during runtime of an application program.

FIG. 9 is a flow diagram of the lookup method of any directory manager object in one embodiment.

FIG. 10 is a flow diagram illustrating an application program using a proxy object.

FIG. 11 is a flow diagram illustrating a method of a proxy object in one embodiment.

### DETAILED DESCRIPTION

A method and system for providing an object-oriented interface to a directory server is provided. The interface system includes a directory compiler and directory interface objects. The directory compiler inputs a schema of a directory and outputs the definitions of various interfaces and objects (e.g., adapters) related to that directory. An application program can then use the interfaces and adapter objects to access the directory in an object-oriented manner.

The directory compiler includes a schema parser and a code generator. The schema parser identifies the classes of objects that are defined by the directory. Each class of object is identified by a class name and the attributes within that class. The attributes have a corresponding characteristic or attribute type. The code generator then outputs an interface definition and an adapter class definition for each class of the directory. For example, a directory may include entries related to employees of a company. The schema may include a class relating to address information of the employees and another class relating to the experience of the employee. The class relating to address information may include the attributes of street address, city, and state. The schema compiler generates an interface definition for each class and a class definition for accessing the attributes associated with the class.

In one embodiment, the directory server provides access through the Lightweight Directory Access Protocol (“LDAP”). The directory server may provide an enterprise-wide accessible location for storing shared data, such as user group identification, user profiles and preferences, access control information, shared service locations and interface definitions, and general resource information. The directory includes a schema and entries. The schema defines the objectclasses of information that can be stored in the entries. Each entry has a unique key, a list of objectclasses of the information contained within the entry, and the values associated with the attributes of each objectclass.

At runtime, an application can access the directory using the object-oriented interface. The interface system provides a directory manager object for retrieving entries from the directory. Each entry is represented by a directory entry object, and each objectclass of a directory entry is represented by an adapter object. To access the directory, an application instantiates a directory manager object for the directory of interest. The application then uses the methods of the directory manager object to retrieve directory entry objects, each corresponding to a directory entry. The application also uses the methods of the directory manager object to retrieve adapter objects, each corresponding to an objectclass associated with a directory entry. The adapter objects provide “set” and “get” methods for setting and retrieving the attributes associated with the directory entry.

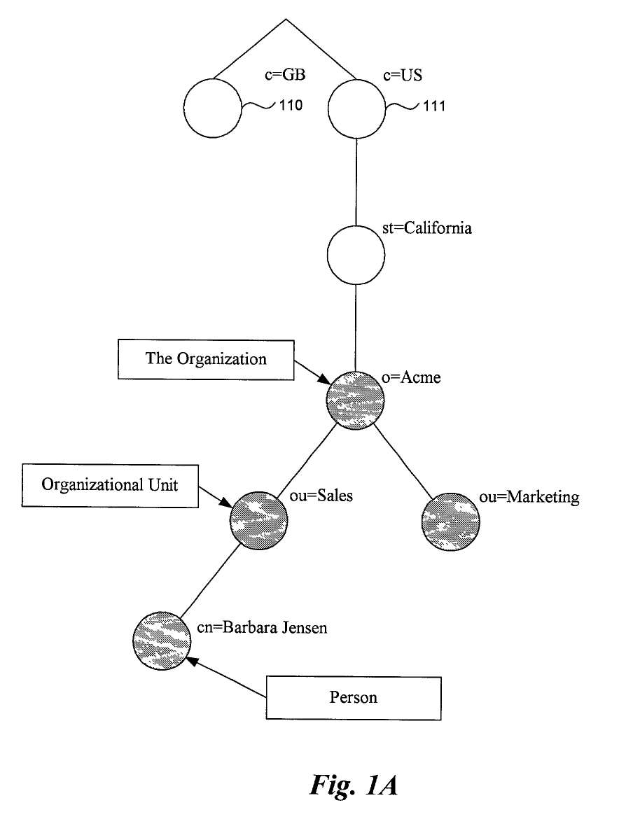

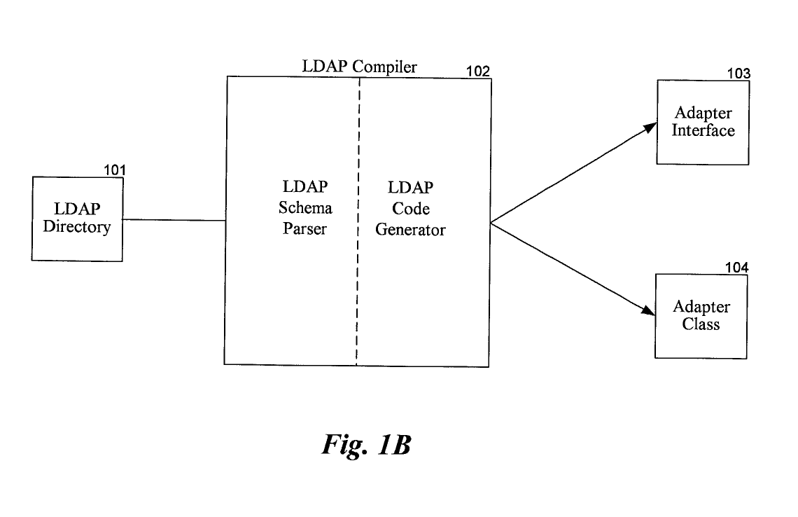

FIG. 1B is a block diagram illustrating the directory compiler. The directory compiler 102 inputs schema information from the LDAP directory 101 and outputs an adapter interface definition 103 and an adapter class definition 104 for each class defined in the LDAP directory. The LDAP schema parser identifies the classes, attributes, and attribute characteristics from the schema of the LDAP directory. The LDAP code generator then generates the interface and adapter definitions. The “Class Generator” section of Appendix A describes a class that can be used to generate interface and adapter definitions for the classes.

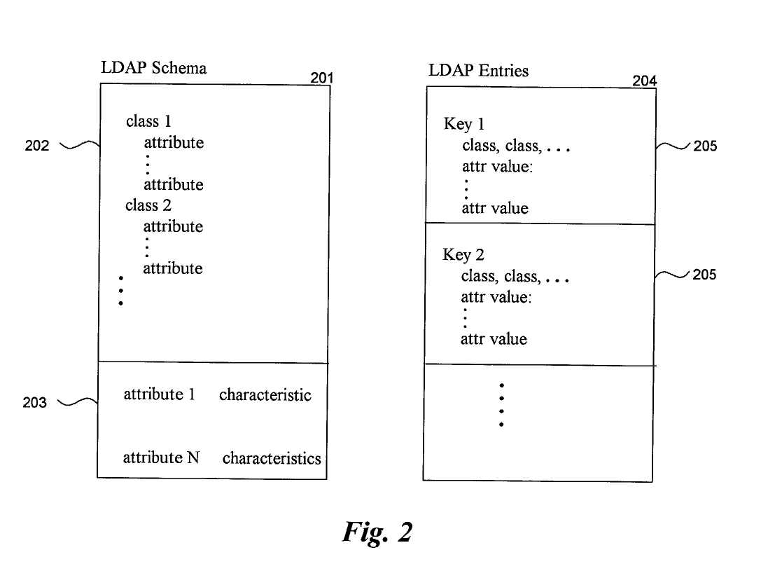

FIG. 2 is a block diagram illustrating an LDAP schema and LDAP directory entries. The LDAP schema 201 contains an objectclass definition section 202 and attribute section 203. The class definition section identifies each objectclass used by the directory along with the attributes defined for that class. For example, an objectclass may be named “employee address information” and may contain the attributes street address, city, and state. The attributes section identifies each attribute that can be used by an objectclass along with the characteristics of that attribute. The characteristics may include the attribute type, such as integer or whether the attribute is multi-valued. Each LDAP entry includes a unique key, the list of objectclasses associated with that entry, and a list of attribute/value pairs. The attribute/value pairs identify the current value associated with the attributes of the objectclasses of the entry.

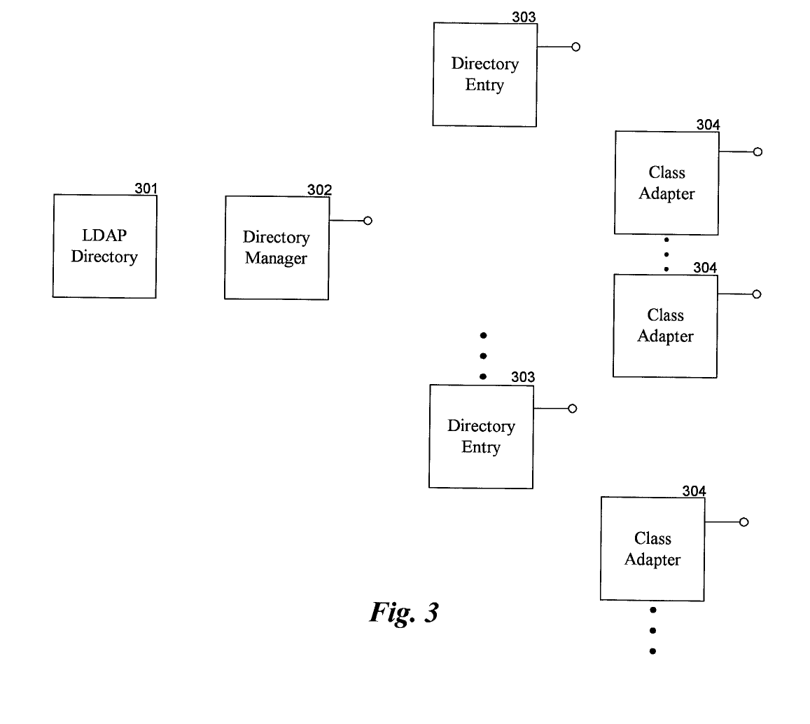

FIG. 3 is a block diagram illustrating the objects generated to access an LDAP directory. A directory manager object 302 corresponds to the LDAP directory 301. The directory manager object provides methods for accessing the data of the directory entries. Each directory entry is represented by a directory entry object 303. The directory entry objects provide a method for retrieving the current context (i.e., the actual directory entry) of a directory entry. Each adapter class provides methods for setting and retrieving the attribute values of a class associated with the directory entry. The “Interface IBaseObjectClass” and the “Class BaseDirectoryAdapter” sections of Appendix A describe the methods of an adapter object. The “Class DirectoryEntry” section of Appendix A describes the methods of the directory entry object. The “Class DirectoryManager” section of Appendix A describes the methods of the directory manager object.

In one embodiment, the client computers and the LDAP server computer are interconnected via a communications channel. The directory manager objects, directory entry objects, and the class adapters may be instantiated at the client computers. The LDAP server computer contains the LDAP directory. the Internet 730. The computers may include a central processing unit, memory, input devices (e.g., keyboard and pointing devices), output devices (e.g., display devices), and storage devices (e.g., disk drives). The memory and storage devices are computer-readable media that may contain instructions that implement the advertisement system. In addition, the data structures and message structures may be stored or transmitted via a data transmission medium, such as a signal on a communications link. Various communications channels other than the Internet may be used, such as the Internet, a local area network, a wide area network, or a point-to-point dial-up connection.

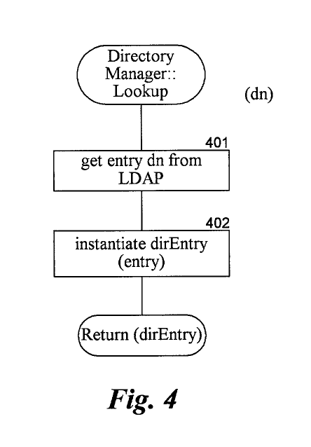

FIG. 4 is a flow diagram illustrating example processing of a lookup method of the directory manager class. The lookup method is passed a key for a directory entry and returns a directory entry object associated with that directory entry. In block 401, the method retrieves the directory entry corresponding to the passed key from the LDAP directory. The method uses the standard LDAP protocol for accessing the entries of an LDAP directory. In block 402, the method instantiates a directory entry object. The instantiation includes initializing the context of the directory entry object. The context corresponds to the actual data contained in the directory entry of the LDAP directory. The method then returns a reference to that directory entry object.

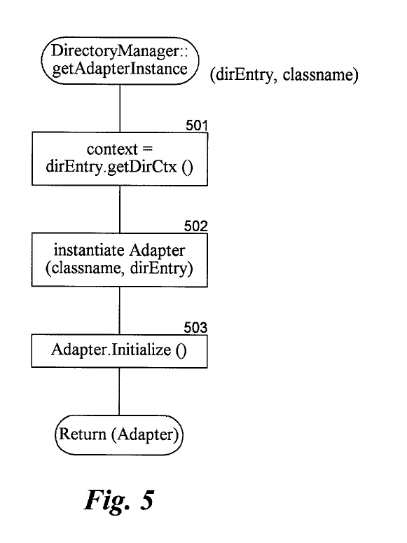

FIG. 5 is a flow diagram illustrating an example get adapter instance method of the directory manager class. This method is passed a directory entry and an objectclass name associated with a desired adapter. The method returns a pointer to an adapter object for the passed objectclass name. In block 501, the method retrieves the context associated with the passed directory entry by invoking the get directory context method of the directory entry. In block 502, the method instantiates an adapter object associated with the passed class name. The adapter object may contain a reference to the associated directory entry object. In block 503, the method initializes the adapter object. This initialization may include the retrieving of the attribute values from the context associated with the directory entry. The method then returns a reference to the adapter object.

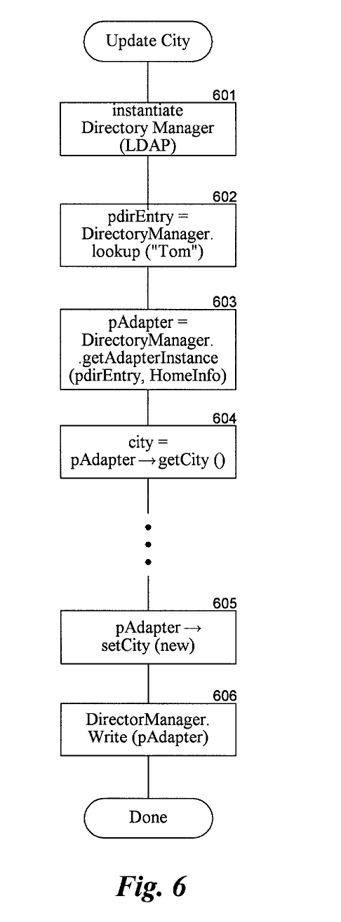

FIG. 6 is a flow diagram illustrating example uses of the object-oriented interface of an LDAP directory. This example illustrates the updating of a city attribute for an employee named “Tom.” In block 601, the application instantiates a directory manager object to interface with a designated LDAP directory. In block 602, the application invokes the lookup method of the directory manager object passing an indication that the key of the directory entry to be looked up is “Tom.” The lookup method returns a pointer to a directory entry object corresponding to the “Tom” entry. In block 603, the application invokes the get adapter instance method of the directory manager object passing a reference to the directory entry object and the name of the objectclass (i.e., “HomeInfo”). The get adapter instance method instantiates an adapter object for the indicated objectclass and returns a pointer to that adapter object. In block 604, the application invokes the get city method of the adapter object to retrieve the current value of the city attribute of the entry. As indicated by the ellipsis, the application processes the city information and may receive a new city value from a user. In block 605, the application invokes the set city method of the adapter object to set the city attribute to its new value. In block 606, the application invokes the write method of the directory manager passing the adapter object. The write method writes the values of the attributes to the directory entry in the LDAP directory. Thus, the write method corresponds to the committing of the changes to the LDAP directory.

Table 1 illustrates a sample adapter interface generated by the directory compiler. In this example, the name of the interface is “IAdapter” followed by the actual class name. This interface inherits the BaseDirectoryAdapter class. The directory compiler generates a set and get method for each attribute of the class. In this example, the name of the get method is “get” followed by the name of the attribute, and the name of the set method is “set” followed by the name of the attribute.

TABLE 1
Interface IAdapter(class) : BaseDirectoryAdapter {

attrtype getAttrName 1( );
attrtype getAttrName2( );
. . .
void setAttrName1(attrtype value);
void setAttrName2(attrtype value);
. . .

}

Table 2 illustrates a sample adapter class generated by the directory compiler. In one embodiment, an adapter class may have a data member corresponding to each attribute for that class. If so, then when a directory context is retrieve for directory entry, then the values of the data members can be set accordingly. The get attribute method returns the value of the corresponding data member. Alternatively, a get method may retrieve the context associated with a directory entry, parse the context, and then return the parsed value each time the method is invoked.

TABLE 2
Interface IAdapter(class) : BaseDirectoryAdapter {

attrtype getAttrName 1( );
attrtype getAttrName2( );
. . .
void setAttrName1(attrtype value);
void setAttrName2(attrtype value);
. . .

}
class Adapter(class) : IAdapter {

attrtype m_AttrName1;
attrtype m_AttrName2;
. . .
attrtype getAttrName1( ){return

(m_AttrName1)};

attrtype getAttrName2( ){

context = m_dirEntry.getDirCtx( );
parse context to retrieve attribute value;
return (parsed value);}

. . .
void setAttrName1(attrtype

value){m_AttrName1 = value;};

. . .

}

In an alternate embodiment, the interface system uses a dynamic proxy class defined by the Java 2 Platform Standard Edition v1.3 provided by Sun Microsystems. Appendix B be contains a description of the dynamic proxy class capabilities. The dynamic proxy class implements a list of interfaces specified at runtime when the class is instantiated. An invocation handler is also specified when the class is instantiated. An application program uses a proxy instance by casting the instance to the interface to be accessed. When the application invokes one of the methods of a cast-to interface, the proxy instance invokes the invocation handler which in turn invokes the corresponding method on the object that implements the interface. The use of a dynamic proxy class allows the application program to access objectclasses and attributes that may have been added to the LDAP directory after the application program was created.

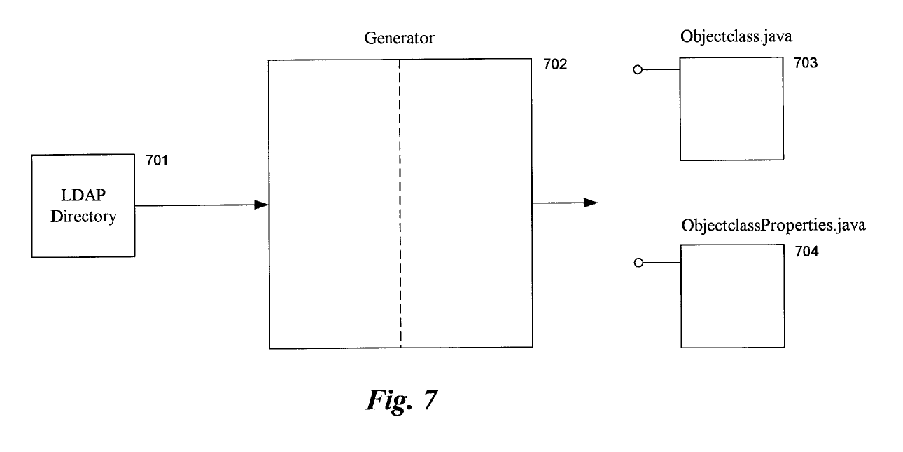

FIG. 7 is a block diagram illustrating components of the interface system in this alternate embodiment. The interface system includes LDAP directory 701, generator 702, Java objects 703, and Java property objects 704. The generator is a class that imports an LDAP directory and generates the Java classes and Java property classes corresponding to the directory entries of the LDAP directory. The generator retrieves each of the directory entries and generates a corresponding Java class with a set and get method for each attribute of the objectclasses of the directory entry. The generator names the Java class with the same name as the name of the objectclass.

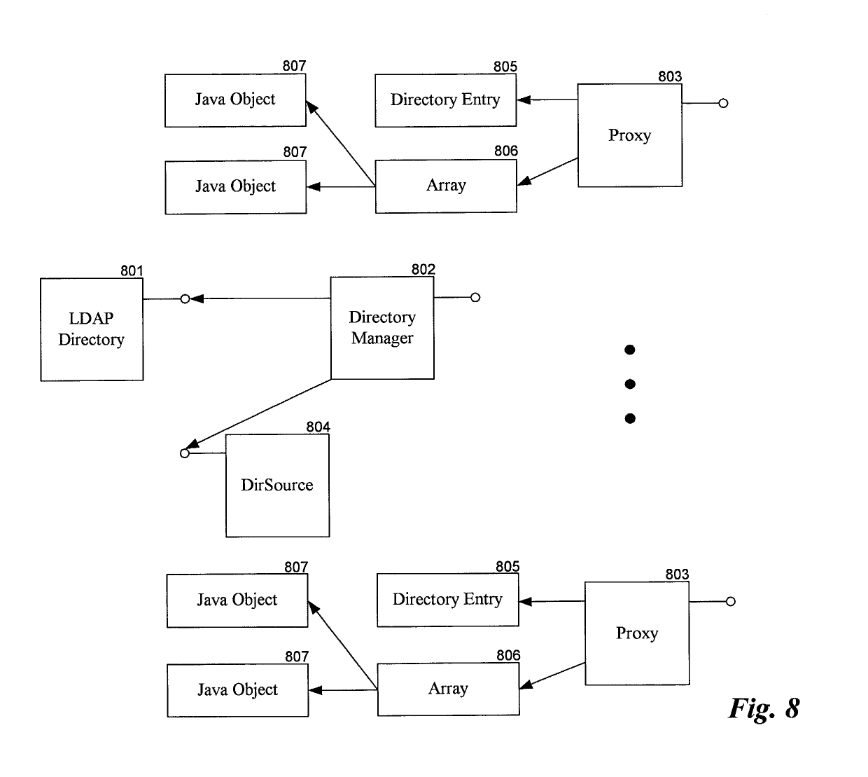

FIG. 8 is a block diagram illustrating objects instantiated during runtime of an application. The objects include an LDAP directory object 801, a directory manager object 802, proxy objects 803, a directory source object 804, directory entry objects 805, arrays 806, and Java objects 807. An application program uses a directory manager factory object (not shown) to instantiate a directory manager object that provides access to an LDAP directory that is specified by the directory source object. The directory source object is passed to the directory manager factory object when the directory manager object is instantiated. The directory manager object provides a lookup method for retrieving proxy objects for LDAP entries. Once an application program retrieves a proxy object, it casts that proxy object to the interface to be accessed. When a proxy object is instantiated by the interface system, it is provided with a directory entry object and an array of references to Java objects that implement those interfaces. The Java objects correspond to the Java classes generated by the generator. When a method of a cast proxy object is invoked by an application, the method invokes the invoke method of the directory entry object passing an identifier of the method invoked by the application and the arguments. The invoke method identifies the Java object from the array and invokes the appropriate method of the Java object. The invoked method of the Java object then accesses the LDAP directory directly.

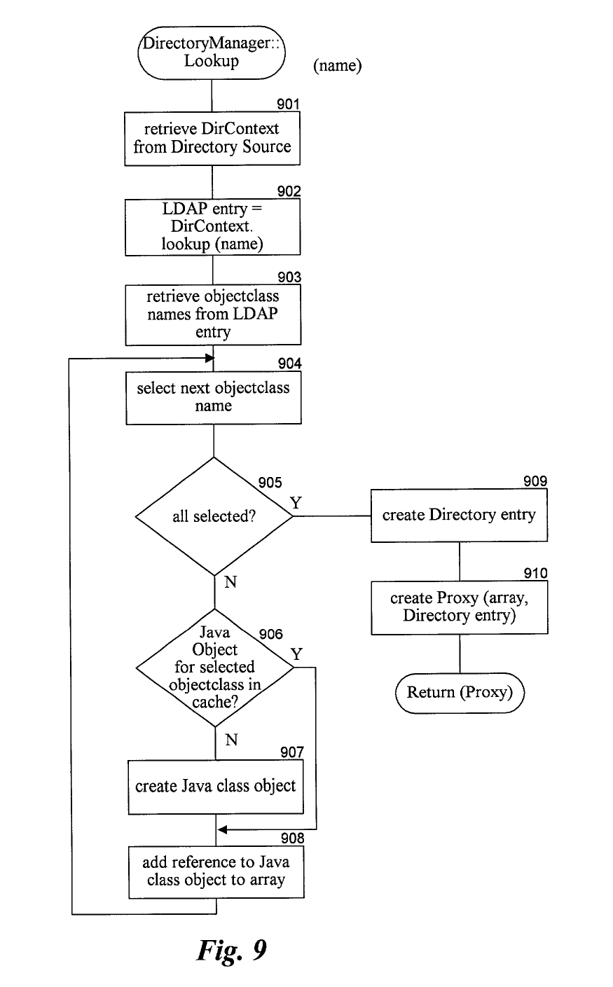

FIG. 9 is a flow diagram of the lookup method of any directory manager object in one embodiment. The lookup method is passed the name of an LDAP directory entry and returns a proxy object corresponding to that directory entry. In block 901, the method retrieves directory context information from the directory source object. Appendix C contains definition of the interfaces used in this embodiment of the interface system. In block 902, the method retrieves the data of the LDAP directory entry. In block 903, the method retrieves the objectclass names for the LDAP directory entry. In blocks 904-908, the method loops instantiating an object for each objectclass name. In block 904, the method selects the next objectclass name. In decision block 905, if all the objectclass names have already been selected, then the method continues at block 909, else the method continues at block 906. In decision block 906, if the Java object for the selected objectclass has already been instantiated, then the method continues at block 908, else the method continues at block 907. In block 907, the method instantiates a Java object for the selected objectclass name. The method instantiates the Java object using the class definitions generated by the generator. In block 908, the method adds a reference to the Java object to the array of interfaces and loops to block 904 to select the next objectclass name. In block 909, the method instantiates a directory entry object. In block 910, the method instantiates a proxy object passing the array of interfaces and the directory entry object to use as an invocation handler. The method then returns a reference to the proxy object.

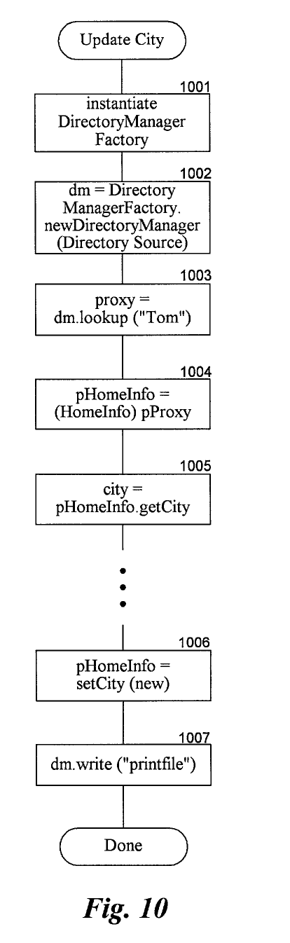

FIG. 10 is a flow diagram illustrating an application using a proxy object. In block 1001, the application instantiates a directory manager factory object. In block 1002, the application invokes the new directory manager method of the directory manager factory object to instantiate a new directory manager object. The application passes to the directory manager factory object a directory source object specifying the LDAP directory. In block 1003, the application invokes the lookup method of the directory manager object and receives a reference to the proxy object in return. In block 1004, the application casts the proxy object to an interface associated with the LDAP directory entry. In block 1005, the application invokes a method of that interface to retrieve an attribute value. In block 1006, the application invokes another method of the cast proxy interface to set an attribute value. In block 1007, the application invokes of the write method of the directory manager object to commit the changes to the LDAP directory entry. The application then completes.

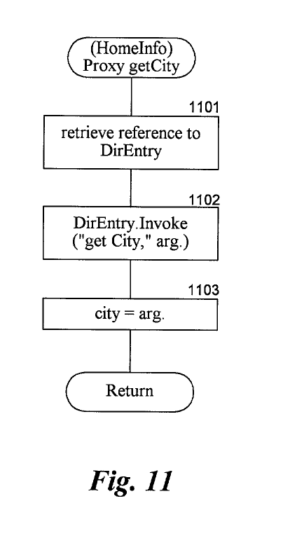

FIG. 11 is a flow diagram illustrating a method of a proxy object in one embodiment. In block 1101, the method retrieves a reference to the directory entry object. In block 1102, the method invokes the invoke method of the directory entry object passing the name of the method to invoke and the arguments to be passed to that invoked method. In block 1103, the method retrieves the returned arguments and then returns.

From the foregoing it will be appreciated that although specific embodiments of the interface system have been described herein for purposes of illustration, various modifications may be made without deviating from the spirit and scope of the invention. Accordingly, the invention is not limited except by the appended claims.

1. A computer-based method for accessing a directory service, the method Comprising:
instantiating a directory manager object having a reference to a directory, the directory having directory entries, each directory entry having an objectclass defining attributes associated with the directory entry and having an identifier;
invoking a lookup function of the instantiated directory manager object passing the identifier of a directory entry, the lookup function for determining the objectclass associated with the identified directory entry, for instantiating an object for the determined objectclass, and for instantiating a proxy object having a reference to the instantiated object for the determined objectclass;
casting the proxy object to an interface for the determined objectclass associated with the identified directory entry; and
invoking a function of the cast-to interface to effect the accessing of the identified directory entry.

2. The method of claim 1 wherein the proxy object has a directory entry object for the determined objectclass and wherein the invoked function of the proxy object invokes a lookup function of directory entry object to handle access to the identified directory entry.

3. The method of claim 2 wherein the instantiated object for the determined objectclass has a get and set function for each attribute of the determined objectclass.

4. The method of claim 3 wherein the lookup function of the directory entry object invokes a get or set function of the instantiated object for the determined objectclass.

5. The method of claim 1 wherein a class for the instantiated object for the determined objectclass is generated by a generator that accesses a schema for the identified directory entry.

6. The method of claim 1 wherein multiple objectclasses are associated with the identified directory entry.

7. The method of claim 1, 2, 3, 4, 5, or 6 wherein the directory service models the lightweight directory access protocol.

8. A computer-based method for providing an object-oriented interface to directory service, the method comprising:
instantiating an object for an identified directory entry of the directory service, each directory entry of the directory service having an objectclass defining attributes associated with the directory entry and having an identifier, the instantiated object having a class definition specifying functions for accessing attributes of the identified directory entry, the class definition being generated by a generator based on the objectclass of the identified directory entry; and
invoking a function of the instantiated object to effect the accessing of the identified directory entry.

9. The method of claim 8 including instantiating a directory manager object with a lookup function for retrieving a reference to an instantiated object for an identified directory entry.

10. The method of claim 8 wherein the instantiated object is a proxy object and including casting the proxy object to an interface associated with the class definition.

11. The method of claim 8, 9, or 10 wherein the directory service models the lightweight directory access protocol.

12. A computer-based method for accessing a directory service, the method comprising:
instantiating a directory manager object having a reference to a directory, the directory having directory entries, each directory entry having an objectclass defining attributes associated with the directory entry and having an identifier;
invoking a lookup function of the instantiated directory manager object passing the identifier of a directory entry, the lookup function for instantiating a directory entry object associated with the identified directory entry and returning a reference the instantiated directory entry object;
invoking a get adapter instance function of the instantiated directory manager object passing the reference to the instantiated directory entry object and receiving a reference to an adapter object associated with the identified directory entry; and
invoking a function of the referenced adapter object to effect the accessing of the identified directory entry.

13. The method of claim 12 including passing an indication of an objectclass when invoking the get adapter instance function.

14. The method of claim 12 wherein a directory entry has multiple objectclasses associated with it.

15. The method of claim 12, 13, or 14 wherein the directory service models the lightweight directory access protocol.

16. A computer system for providing an object-oriented interface to directory service that models the lightweight directory access protocol, comprising:
means for instantiating an object for an identified directory entry of the directory service, each directory entry of the directory service having an objectclass defining attributes associated with the directory entry and having an identifier, the instantiated object having a class definition specifying functions for accessing attributes of the identified directory entry; and
means for invoking a function of the instantiated object to effect the accessing of the identified directory entry.

17. The system of claim 16 including means for instantiating a directory manager object with a lookup function for retrieving a reference to an instantiated object for an identified directory entry.

18. The system of claim 16 wherein the instantiated object is a proxy object and including casting the proxy object to an interface associated with the class definition.

19. A computer computer-readable medium containing instructions for controlling a computer system to access a directory service employing a lightweight directory access protocol, by a method comprising:
invoking a lookup function of an directory manager object passing an identifier of a directory entry, the directory manager object having a reference to a directory, the directory having directory entries, each directory entry having an objectclass defining attributes associated with the directory entry and having an identifier, the lookup function for determining the objectclass associated with the identified directory entry and for returning a proxy object having a reference to an object associated with the objectclass;
casting the proxy object to an interface associated with objectclass of the identified directory entry; and
invoking a function of the cast-to interface to effect the accessing of the identified directory entry.

20. The computer-readable medium of claim 19 wherein the proxy object has a directory entry object for the associated objectclass and wherein the invoked function of the proxy object invokes a lookup function of directory entry object to handle access to the identified directory entry.

21. The computer-readable medium of claim 19 wherein the object associated with the objectclass has a get and set function for each attribute of the associated objectclass.

22. The computer-readable medium of claim 21 wherein the lookup function of the directory entry object invokes a get or set function of the associated objectclass.

23. The computer-readable medium of claim 19 wherein a class for the instantiated object associated with the objectclass is generated by a generator that accesses a schema for the identified directory entry.

24. The computer-readable medium of claim 19 wherein multiple objectclasses are associated with the identified directory entry.
